(19) United States
(12) Patent Application Publication
(10) Pub. No.: US 2005/0221777 A1
(43) Pub. Date: Oct. 6, 2005

(54) Radiofrequency data signal reception device and method for implementing the same

(75) Inventors: Thierry Melly, Lausanne (CH); Erwan Leroux, Neuchatel (CH)

Correspondence Address: SUGHRUE MION, PLLC, 2100 PENNSYLVANIA AVENUE, N.W., SUITE 800, WASHINGTON, DC, 20037, US

(73) Assignee: CSEM

(21) Appl. No.: 11/094,177

(22) Filed: Mar. 31, 2005

(30) Foreign Application Priority Data
Apr. 2, 2004 (EP) 04101369.9

(51) Int. Cl. H04B 7/185

(52) U.S. Cl. 455/233.1; 455/230

(57) ABSTRACT

The radiofrequency data signal reception device (1) includes at least two frequency conversion stages (2, 3) for converting radiofrequency data signals (RF1, RF2) of first and second different carrier frequencies into intermediate signals (S_{IF1}, S_{IF2}) with an identical frequency lower than the carrier frequencies of the radiofrequency signals. These intermediate signals are received by a channel selection unit (4) which can provide data signals (S_{I,Q}) relating to the intermediate signals to a signal processing unit (6) for demodulation of the data signals. An oscillator stage (5) of the device provides oscillating signals (S_{O11}, S_{O12}, S_{O21}, S_{O22}) to the frequency conversion stages for the frequency conversion operations. The channel selection unit (4) includes an adder element (41) for adding the first and second intermediate signals, and a signal intensity indicator (43) checking the intensity level of the intermediate signals. Control signals (INT₁, INT₂) allow one or two frequency conversion stages to be placed in operating or rest mode if the checked intensity level (NIV) is lower than or higher than a reference intensity level.

This application claims priority from European Patent Application No. 04101369.9 of Apr. 2, 2004, the entire disclosure of which is incorporated herein by reference.

The invention concerns a radiofrequency data signal reception device. The device includes at least two frequency conversion stages for converting radiofrequency data signals into intermediate signals of a lower frequency than the radiofrequency signal carrier frequency. These intermediate signals are supplied to a channel selection unit, which delivers corresponding data signals to a signal processing unit for demodulating said data signals. An oscillator stage of the device supplies oscillating signals to the frequency conversion stages for the frequency conversion operations. The oscillator stage also supplies a clock signal to the processing unit to clock particularly the data signal demodulating operations.

The invention also concerns a method for implementing the radiofrequency data signal device.

The radiofrequency data signal reception device can be used for example in applications relating to home automation, i.e. for monitoring the opening and closing of the doors of a building or for detecting the presence or movement of people. In order to do this, several sensors measuring various parameters are placed at different locations in the building to be monitored. These sensors are capable of transmitting an information at a short distance, via radiofrequency signals, to a reception device. When an event occurs, one of the sensors will transmit a simple information to the reception device, for example, one information bit modulated in the radiofrequency signals.

In the same restricted space, several sensors can transmit radiofrequency data signals to be sensed via one or several particular reception devices. Consequently, it may happen that other reception devices pick up radiofrequency signals intended for at least one specific reception device. Collisions may thus occur between radiofrequency signals to be picked up during various data communications.

In order to avoid such problems, the use of different radiofrequency signal transmission and reception channels is known. The reception device can thus comprise different reception channels operating in parallel and the channel having the best radiofrequency signal reception is then selected.

Since the reception device according to the present invention has its own power source, its electrical energy consumption has to be low in order to guarantee sufficient autonomy for the system. Consequently, all of the energy consuming elements of the reception device must not, if possible, be permanently switched on, in particular when no useful information can be detected. Moreover, when the device is switched on, the various received signal processing and data demodulating operations have to be executed quickly in order to save energy.

It is thus an object of the invention to provide a radiofrequency data signal reception device capable of quickly deciding whether useful information is being received and having, on the one hand, reduced electrical energy consumption and, on the other hand, as small as possible a number of components necessary for processing the received signals. The decision, relating to the usefulness of the information transmitted by the radiofrequency signals, must be made before the data demodulating operations.

The invention therefore concerns a radiofrequency data signal reception device which comprises the features mentioned in claim 1.

Advantageous embodiments of the device are defined in the dependent claims 2 to 7.

One advantage of the reception device according to the invention lies in the fact that the signal intensity indicator is arranged in a channel selection unit which precedes the signal processing unit in which the demodulating operations are carried out. Consequently, a quick decision as to a useful information picked up can be taken before undertaking the long demodulating steps in the signal processing unit.

If no useful radiofrequency signal information can be detected, the frequency conversion stages are momentarily placed in a rest mode. They are reactivated at determined time intervals to ensure monitoring and to be able to check whether useful radiofrequency data signals of sufficient intensity are being picked up. They can be placed in operating mode, for example every second, without excessively affecting the electrical energy consumption of the device.

By picking up radiofrequency data signals of sufficient intensity in at least one of the frequency conversion stages, the intensity indicator can check whether the level of intensity is higher than or equal to a reference level of intensity. This consequently means that only one of the two frequency conversion stages can be selected to be kept in operating mode. The selected conversion stage is the one which has the highest level of generated intermediate signal intensity in order to be able to demodulate the data signals thereafter in the signal processing unit.

Another advantage of the reception device according to the invention lies in the fact that the two frequency conversion stages, each defining a specific reception channel, receive radiofrequency data signals at a different carrier frequency. Given that the first carrier frequency of the radiofrequency signals received by the first frequency conversion stage is quite different from the second carrier frequency of the radiofrequency signals received by the second frequency conversion stage, there is no frequency overlap between the reception channels. The first carrier frequency (for example, 434 MHz) is, preferably, double that of the second carrier frequency (868 MHz).

With these two frequency conversion stages, it is possible to select, owing to the intensity indicator, the best reception channel when the intermediate signals have a intensity level higher than or equal to the reference intensity level. Consequently, with two reception channels, the probability of scrambling is reduced. This also gets around the problem of radiofrequency data signal collisions between the specific reception device and other transmission and reception devices communicating in proximity.

The invention also concerns the method for implementing the radiofrequency data signal reception device, which includes the features mentioned in claim 8.

Particular steps of the method are defined in the dependent claims 9 and 10.

One advantage of the method for implementing the reception device according to the invention lies in the fact that a check of the intensity of the intermediate signals is carried out quickly before the data signal demodulating operations. This allows electrical energy to be saved if the device detects no useful information by placing the frequency conversion stages momentarily in a rest mode.

Preferably, after having checked a level of intensity higher than or equal to the reference intensity level when the two conversion stages are operating, a new intensity check is carried out successively for each frequency conversion stage. This second intensity check determines which frequency conversion stage is supplying the intermediate signals with the highest intensity in order to select the corresponding reception channel.

The objects, features and advantages of the radiofrequency data signal reception device, and the method for implementing the same, will appear more clearly in the following description of at least one embodiment illustrated by the drawings, in which:

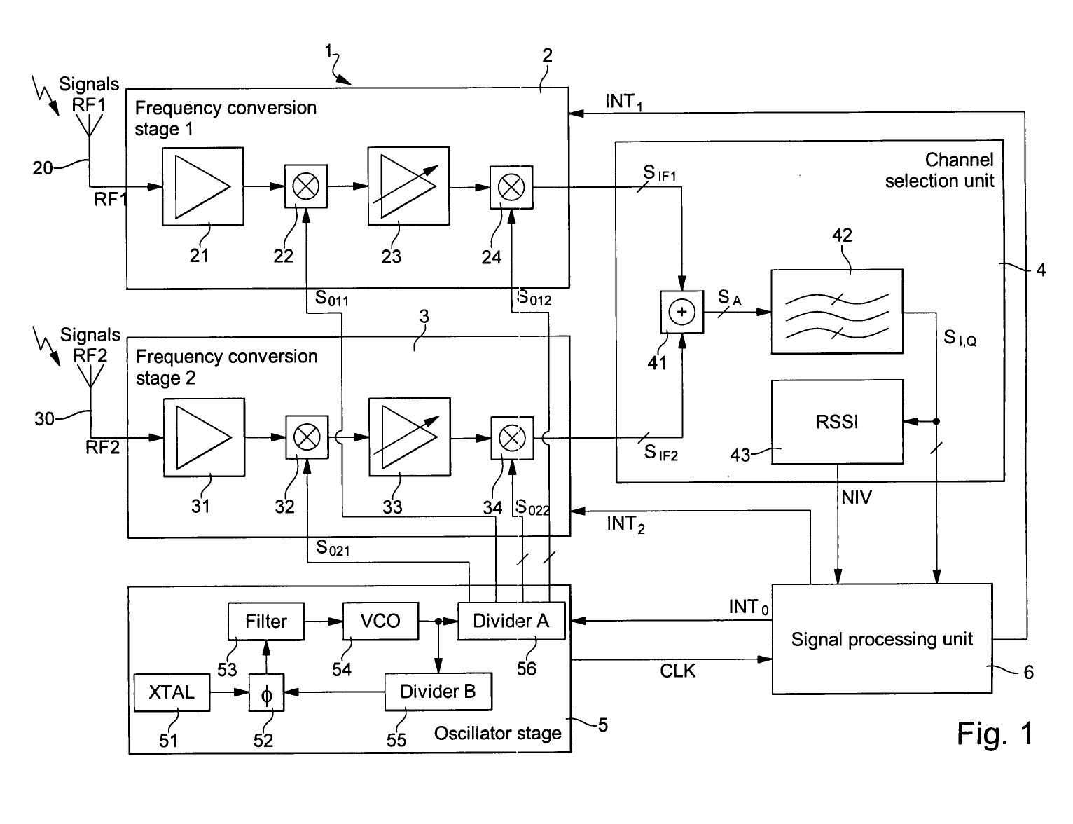

FIG. 1 shows schematically a radiofrequency data signal reception device according to the invention;

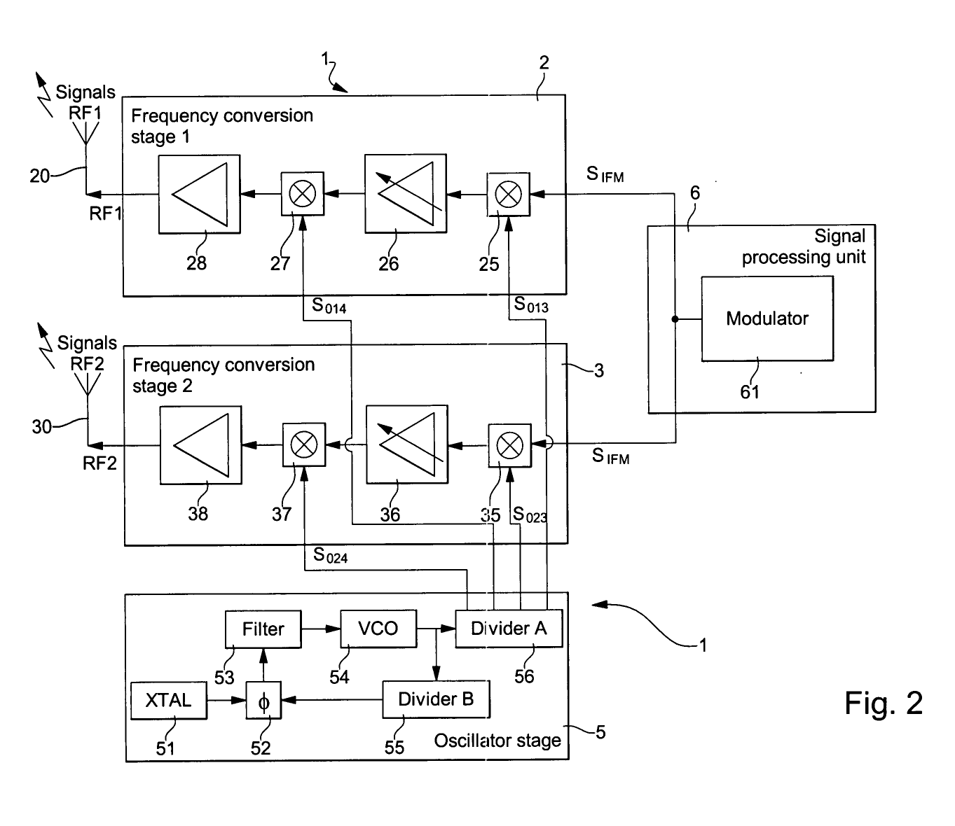

FIG. 2 shows schematically part of a transmission of complementary radiofrequency signals from the radiofrequency signal reception device according to the invention.

In the following description, those electronic components of the reception device, which are well known to those skilled in the art in this technical field, will only be described in a simplified manner. For more details relating to the various components of the reception device, the reader can refer to the teaching drawn from the book by Mr. Behzad Razavi entitled, “RF Microelectronics”, Prentice Hall, ISBN-0-13-887571-5.

FIG. 1 shows generally the electronic components of the radiofrequency data signal reception device 1 according to the invention. This device can be used in a low power electronic apparatus, such as a portable telephone or a watch or an electronic badge for example, without however being limited to use solely in such an apparatus. It can form part of a surveillance system for receiving information from sensors carried by users in order to follow their movement or check their presence in the building.

Radiofrequency data signal reception device 1 includes two frequency conversion stages 2 and 3, a single channel selection unit 4 connected to each frequency conversion stage, a signal processing unit 6 receiving data signals from channel selection unit 4, and an oscillator stage 5. Oscillator stage 5 of the device generates oscillating signals S_{O11}, S_{O12}, S_{O21} and S_{O22} for the frequency conversion operations for the radiofrequency signals received by the frequency conversion stages. The oscillator stage also generates at least one clock signal CLK for signal processing unit 6 for clocking, in particular, the data signal demodulating operations.

This oscillator stage 5 is formed in a conventional manner of a phase locked loop unit. It therefore includes a quartz crystal reference oscillator XTAL 51, a phase/frequency detector Φ 52, a low-pass filter 53, a voltage controlled oscillator VCO 54, a first divider A 56 and a second divider B 55 in the loop. Reference oscillator 51 generates a periodic reference signal of the order of 12 MHz, whereas the voltage controlled oscillator VCO 54 generates a high frequency of the order of 772 MHz. Divider A, which receives the high frequency signal from voltage controlled oscillator 54, includes several division elements so as to generate oscillating signals S_{O11}, S_{O12}, S_{O21} and S_{O22}.

In reception mode, the first frequency conversion stage 2, which defines a first reception channel, receives via a first bandpass filter antenna 20, radiofrequency data signals at a first carrier frequency RF1. Radiofrequency signals RF1 are converted in the first frequency conversion stage in order to supply first intermediate signals S_{IF1}, having a lower defined frequency than the first carrier frequency RF1 to channel selection unit 4.

In reception mode, the second frequency conversion stage 3, which defines a second reception channel, receives via a second bandpass filter antenna 30, radiofrequency data signals at a second carrier frequency RF2, which is different from the first carrier frequency. Radiofrequency signals RF2 are converted in the second frequency conversion stage in order to supply second intermediate signals S_{IF2}, having a lower defined frequency than second carrier frequency RF2, to channel selection unit 4. The frequency of the first and second intermediate signals S_{IF1} and S_{IF2} is equal so that it can be processed by a single channel selection unit.

Preferably, the value of the second carrier frequency of radiofrequency signals RF2 can be twice the value of the first carrier frequency of radiofrequency signals RF1. The first carrier frequency can be equal, for example, to 434 MHz, whereas the second carrier frequency can be equal to 868 MHz without however being limited to these frequency values.

With such a significant difference between the two carrier frequencies of radiofrequency signals RF1 and RF2 capable of being picked up by antennae 20 and 30, there is thus no frequency overlap between the two reception channels. Moreover, the bandwidth of the first channel can be of the order of 600 kHz, whereas the bandwidth of the second channel can be of the order of 200 kHz. Consequently, it is possible to select one or other of the reception channels for better reception of the radiofrequency data signals.

For the frequency conversion of radiofrequency signals RF1, the first frequency conversion stage 2 includes, connected in series, a low noise filter amplification element 21, which receives radiofrequency signals RF1, a first mixer block 22, a variable gain amplifier element 23 and a second mixer block 24. With the two mixer blocks 22 and 24, there is a double frequency conversion of radiofrequency signals RF1 in order to supply the first intermediate signals S_{IF1} to channel selection unit 4.

The first mixer block 22 of the differential type, brings the carrier frequency of radiofrequency signals RF1 to around 48 MHz using the first oscillating signal S_{O11} with a frequency close to 386 MHz. This oscillating signal S_{O11} is provided by divider A 56 after a division-by-2 of the high frequency signal generated by voltage controlled oscillator 54. The second mixer block 24 of the differential type finally returns the carrier frequency to close to 0 via second oscillating signals S012 with a frequency close to 48 MHz. The divider A 56 provides these second oscillating signals S012 after a division-by-16 of the high frequency signal of oscillator 54. Consequently, the data frequency spectrum of the first intermediate signals is after conversion preferably close to 0.

The second mixer block 24 preferably includes two mixers for, on the one hand, providing intermediate in phase signals and, on the other hand, intermediate in quadrature signals, as a result of two well known oscillating in phase and in quadrature signals S_{O12}. These oscillating signals S012 and the first intermediate signals S_{IF1} are thus indicated in the drawing by a line intersected by an oblique bar defining a signal bus.

For the frequency conversion of radiofrequency signals RF2, the second frequency conversion stage 3 includes, connected in series, a low noise filter amplification element 31, which receives radiofrequency signals RF2, a first mixer block 32, a variable gain amplifier element 33 and a second mixer block 34. With the two mixer blocks 32 and 34, there is a double frequency conversion of radiofrequency signals RF2 in order to supply the second intermediate signals S_{IF2} to channel selection unit 4.

The first mixer block 32 of the differential type, brings the carrier frequency of radiofrequency signals RF2 to around 96 MHz using the first oscillating signal S_{O21} with a frequency close to 722 MHz. This oscillating signal S_{O21} corresponds to the high frequency signal generated by voltage controlled oscillator 54. The second mixer block 34 of the differential type finally returns the carrier frequency to close to 0 via second oscillating signals S_{O22} with a frequency close to 96 MHz. The divider A 56 provides these second oscillating signals S_{O22} after a division-by-8 of the high frequency signal of oscillator 54. Consequently, the data frequency spectrum of the second intermediate signals is after conversion preferably close to 0.

The second mixer block 34 preferably includes two mixers for, on the one hand, providing intermediate in phase signals and, on the other hand, intermediate in quadrature signals, as a result of two well known oscillating in phase and in quadrature signals S_{O22}. These oscillating signals S_{O22} and the second intermediate signals S_{IF2} are thus indicated in the drawing by a line intersected by an oblique bar defining a signal bus.

Channel selection unit 4, which includes the essential elements of the reception device according to the invention, includes an adder element 41, for adding the first and second intermediate signals provided by the frequency conversion stages, and a received signal intensity indicator RSSI 43. A bandpass filter 42 is placed at the output of adder element 41 in order to filter the added intermediate signals S_{A} and thus provide filtered data signals S_{I,Q} to the RSSI block and to signal processing unit 6 for data signal demodulating operations.

Added intermediate signals S_{A}, like the filtered data signals S_{I,Q}, are also formed by in phase and in quadrature signals. They are shown in FIG. 1 by a line intersected by an oblique bar defining a signal bus.

Intensity indicator 43 carries out a check of the intensity of the intermediate signals after filtering by filter 42 and provides a checked intensity level value NIV to the signal processing unit so as to carry out, in processing unit 6, a comparison with a determined reference intensity level stored in processing unit 6.

If the intensity level of filtered intermediate signals S_{I,Q} is lower than a reference intensity level, signal processing unit 6 supplies a control signal INT₁ to the first frequency conversion stage and a control signal INT₂ to the second frequency conversion stage in order to place them momentarily in a rest mode. The two frequency conversion stages are kept in this rest mode, for example for a period of time of the order of 1 second before being again placed in operating mode. This allows the device to check whether useful radiofrequency data signals can be picked up with sufficient intensity, even if for most of the time, for example 99% of the time, the reception device is switched on without receiving any useful radiofrequency data signals.

According to the invention, it has been observed that it is preferable to switch on the two frequency conversion stages in the same time, rather than in succession.

If the intensity level of added intermediate signals S_{A} checked by intensity indicator 43 is higher than or equal to the reference intensity level, selection has to be made of the best channel. In order to do this, a second intensity check has to be carried out by intensity indicator 43 on the one hand for the intermediate signals S_{IF1} provided by the first frequency conversion stage 2, and on the other hand, for intermediate signals S_{IF2} provided by second frequency conversion stage 3.

Signal processing unit 6 will thus provide a control signal INT₁ to the first frequency conversion stage that is different from the control signal INT₂ provided to the second frequency conversion stage. In this way, the first frequency conversion stage is placed first of all in operating mode, whereas the second frequency conversion stage is placed in rest mode until the intensity level of the first intermediate signals S_{IF1} has been checked. Then, the second frequency conversion stage is placed in operating mode, whereas the first frequency conversion stage is placed in rest mode until the intensity level of the second intermediate signals S_{IF2} has been checked.

On the basis of the checked level of the first and second intermediate signals, processing unit 6 will select frequency conversion stage 2 or 3, whichever has generated the strongest intermediate signals, by placing the other frequency conversion stage in rest mode. The operating frequency conversion stage will thus generate intermediate signals to channel selection unit 4 which will filter the intermediate signals and provide data signals S_{I,Q} to signal processing unit 6. The signal processing unit can thus carry out the data demodulating operations using clock signal CLK produced by oscillator stage 5.

It should be noted that for the second intensity level check, the intermediate signals provided by the second frequency conversion stage can be checked before the intermediate signals provided by the first frequency conversion stage.

Even with a double check of the intermediate signal intensity level, the energy consumption of the device remains low, since the device is only able to pick up useful radiofrequency signals episodically. It is only in approximately 1% of the device's operating time that the intensity level checked by the intensity indicator is higher than the reference intensity level.

Because of this intensity level check carried out in channel selection unit 4 by intensity level indicator 43, a quick decision can be taken as to whether useful radiofrequency data signals have been picked up by at least one bandpass filter antenna 20 or 30. With this quick decision, an energy saving can be made which is an object of the present invention, given that the reception device is preferably powered by an energy source such as a battery or accumulator.

It should be noted that, in order to place one of the frequency conversion stages or the other into rest mode, the signal processing unit can also provide a control signal INT₀ to the oscillator stage. Consequently, this allows some oscillating signals provided to one frequency conversion stage or the other to be momentarily interrupted.

Preferably, all the components of radiofrequency signal reception device 1 are integrated in a single semiconductor substrate integrated circuit. The integrated circuit can be made for example in CMOS technology at 0.18 μm, and operate at a supply voltage comprised between 0.9 and 1.5 V. Consequently, with a single channel selection unit 4, a significant space saving can be achieved.

FIG. 2 shows schematically a complementary radiofrequency signal transmission part of the radiofrequency signal reception device according to the invention. It should be noted that the elements of FIG. 2, which correspond to those of FIG. 1, bear identical reference signs. Consequently, for the sake of simplification, the description of these elements will not be repeated.

Signal processing unit 6 includes a well known modulator 61 which supplies identical modulated intermediate signals S_{IFM} (base band data signals) to the first and second frequency conversion stages 2 and 3 in a transmission mode of the device. In this transmission mode, a rise in frequency of modulated intermediate signals S_{IFM} is achieved simultaneously in both frequency conversion stages. The first frequency conversion stage will produce radiofrequency data signals RF1 on a first carrier frequency to be transmitted by antenna 20, whereas the second frequency conversion stage will produce radiofrequency data signals RF2 on a second carrier frequency to be transmitted by antenna 30.

In order to do this, the first frequency conversion stage includes, connected in series between signal processing unit 6 and antenna 20, a first mixer block 25, a variable gain amplifier element 26, a second mixer block 27 and a low noise filter amplification element 28. Likewise, the second frequency conversion stage includes, connected in series between signal processing unit 6 and antenna 30, a first mixer block 35, a variable gain amplifier element 36, a second mixer block 37 and a low noise filter amplification element 38. Oscillating signals S_{O13}, S_{O14}, S_{O23} and S_{O24} for the frequency conversion operations are provided to the mixer blocks of each frequency conversion stage by oscillator stage 5.

It should be noted that in the transmission mode, one could envisage using switch elements that are not shown, controlled by signal processing unit 6, in order to be able to use the same elements of each of the frequency conversion stages in reception mode.

From the description that has just been given, those skilled in the art can envisage multiple variants of the reception and transmission device without departing from the scope of the invention defined by the claims. A single frequency conversion may be made in each frequency conversion stage in order to provide intermediate signals to the channel selection unit. Moreover, the number of frequency conversion stages may be larger than two, while keeping a single channel selection unit. With several frequency conversion stages, the spectral diversity is greater, which allows a better selection of a reception channel to prevent collisions with any other radiofrequency signals.

1. A radiofrequency data signal reception device, the device including:
at least two frequency conversion stages for converting, in reception mode, received radiofrequency data signals into intermediate signals of a lower frequency than the radiofrequency signal carrier frequency,
a channel selection unit for receiving the intermediate signals from the two frequency conversion stages and providing data signals corresponding to the intermediate signals,
a signal processing unit capable of demodulating the data signals provided by the channel selection unit, and
an oscillator stage providing at least a first oscillating signal to the first frequency conversion stage and at least a second oscillating signal to the second frequency conversion stage for the received radiofrequency signal frequency conversion operations, and a clock signal to the processing unit for clocking particularly data signal demodulating operations,
wherein the oscillator stage is configured to provide first and second oscillating signals of different frequencies in a reception mode so that the first frequency conversion stage can convert radiofrequency data signals received on a first carrier frequency, in a first reception channel, into first intermediate signals having a defined frequency, and so that the second frequency conversion stage can convert radiofrequency signals received on a second carrier frequency different from the first carrier frequency, in a second reception channel, into second intermediate signals, having the same defined frequency as the first intermediate signals, and
wherein the single channel selection unit includes an adder element for adding the first and second intermediate signals, and a signal strength indicator checking the strength level of the intermediate signals to place the frequency conversion stages into a momentary rest mode if the checked strength level is less than a reference strength level, or to select one of the frequency conversion stages to be placed or kept in operating mode, if the checked strength level is higher than or equal to the reference strength level in order to allow demodulation of the data signals in the processing unit.

2. The reception device according to claim 1, wherein the strength indicator checks the strength level of the added and filtered intermediate signals in order to provide an indication of the checked strength level to the signal processing unit, and wherein the signal processing unit provides a first control signal to the first frequency conversion stage and a second control signal to the second frequency conversion stage to place or keep the first conversion stage and/or the second conversion stage in operating mode or in rest mode on the basis of the result of the comparison between the checked strength level and the reference strength level.

3. The reception device according to claim 1, wherein the oscillator stage provides two first oscillating signals of different frequencies respectively to two signal mixer blocks in the first frequency conversion stage and two second oscillating signals of different frequencies respectively to two signal mixer blocks in the second frequency conversion stage so as to carry out a double frequency conversion of the radiofrequency signals received in each frequency conversion stage and to provide first and second intermediate signals at a low frequency or without any carrier frequency.

4. The reception device according to claim 1, wherein it includes a first bandpass filter antenna connected to the first frequency conversion stage to pick up radiofrequency signals with a first carrier frequency from a first reception channel and a second bandpass filter antenna connected to the second frequency conversion stage to pick up radiofrequency signals with a second carrier frequency from a second reception channel without any frequency overlap with the first reception channel.

5. The reception device according to claim 4, wherein the first and second antennae are configured to pick up respectively radiofrequency signals with a first carrier frequency and radiofrequency signals with a second carrier frequency of twice the value of the first carrier frequency, the first carrier frequency preferably being equal to 434 MHz, whereas the second carrier frequency is preferably equal to 868 MHz.

6. The radiofrequency data signal reception and transmission device according to claim 4, wherein the signal processing unit includes a single base band modulator for data signals, which are provided to each frequency conversion stage in a transmission mode of the device, and wherein, in transmission mode, the oscillator stage provides at least a third oscillating signal to the first frequency conversion stage and at least a fourth oscillating signal to the second frequency conversion stage to raise the frequency of the data signals in order to transmit radiofrequency signals at a first frequency via the first antenna and radiofrequency signals at a second frequency via the second antenna.

7. The reception device according to claim 1, wherein all of the components of the device are integrated in a single semiconductor substrate integrated circuit.

8. A method for implementing the reception device according to claim 1, wherein the method includes a series of steps consisting in:
a) switching on the two frequency conversion stages so that the first conversion stage can convert radiofrequency data signals with a first carrier frequency into first intermediate signals, and so that the second conversion stage can convert radiofrequency data signals with a second carrier frequency different from the first carrier frequency into second intermediate signals with an equivalent frequency to the first intermediate signals,
b) adding, in an adder element of the single channel selection unit, the first and second intermediate signals provided by the first and second frequency conversion stages,
c) checking the strength level of the intermediate signals via a signal strength indicator, and
d) placing the two frequency conversion stages into a momentary rest mode if the checked strength level is lower than a reference strength level, or
e) selecting one of the frequency conversion stages to be placed or kept in operating mode, if the checked strength level is higher than or equal to the reference strength level in order to allow demodulation, in the processing unit, of the data signals provided by the channel selection unit.

9. The method according to claim 8, wherein steps a) to d) are repeated automatically and successively at determined intervals of time until the strength level checked at the output of the adder by the strength indicator is equal to or higher than the reference strength level.

10. The method according to claim 8, wherein between step c) and step e) in the case where the first strength level check by the strength indicator is equal to or higher than the reference strength level, the first and second frequency conversion stages are switched on in succession so that the strength indicator carries out a second check of the strength level of the first and second intermediate signals separately at the output of the adder element so as to allow the processing unit to select the frequency conversion stage that was able to produce intermediate signals of the highest strength.
